(19) United States
(12) Patent Application Publication
(10) Pub. No.: US 2010/0185528 A1
(43) Pub. Date: Jul. 22, 2010

(54) METHOD FOR ELECTRONIC COMMERCE USING POINTS, SYSTEM AND RECORDING MEDIUM THEREOF

(76) Inventors: Keun Soo YUN, Seoul (KR); Eun Hee KIM, Seoul (KR)

Correspondence Address: CHRISTOPHER PAUL MITCHELL, 888 16TH ST., NW, SUITE 800, WASHINGTON, DC, 20006, US

(21) Appl. No.: 12/690,920

(22) Filed: Jan. 20, 2010

(30) Foreign Application Priority Data
Jan. 20, 2009 (KR) 10-2009-0004648

(51) Int. Cl. G06Q 30/00

(52) U.S. Cl. 705/27; 705/26

(57) ABSTRACT

Embodiments of the present invention relate to a method for electronic commerce, a system, and a recording medium thereof, and more particularly, to a method for electronic commerce using a point on the basis of the grade of a member depending on the position and code of each of a GM member and an SM member on-line, an electronic commerce system, and a recording medium readable by a computer. A method for electronic commerce, an electronic commerce system, and a computer-readable recording medium of embodiments of the present invention have advantages of creating an increase in the number of members having loyalty by enhancing an association relationship between members and providing a higher incentive to a member inducing membership joining and the resultant activation of an on-line enterprise.

### RELATED APPLICATIONS

This application claims priority under 35 U.S.C. §119(e) from Korean Patent Application No. 10-2009-0004648, filed Jan. 20, 2009 in the Korean Intellectual Property Office, which is incorporated herein by reference in its entirety.

### BACKGROUND

1. Field of the Invention

Embodiments of the present invention relate to a method for electronic commerce, a system, and a recording medium thereof. More particularly, embodiments relate to a method for electronic commerce using points on the basis of the grade of a member depending on the position and code of each of a GM member and an SM member on-line, an electronic commerce system, and a recording medium readable by a computer.

2. Description of the Related Art

In recent years, the Internet globally has had a tremendous influence on society (including culture, the economy, etc.) as a whole. This is due to the large number of Internet users, which rapidly increased from 1999, and the activities of industries related to the Internet (e.g., Internet shopping malls, news, information searching, stocks, association activities, etc.) Some of the services available online are used free of charge, while other sites can be used by only persons who acquire qualifications of members through membership joining.

An economical value of an enterprise depends on the number of members possessed by each on-line enterprise and the advertising revenues generated by the members. Whether or not members having high royalty are secured and their numbers increased is an important component and an important task deciding the success or failure of the business in the on-line industry.

Therefore, on-line enterprises induce an increase of use frequency of their sites and an increase in their numbers of members by inducing each member to revisit the site through a method of discounting. This discounting may be by a predetermined amount of money or a predetermined ratio or reserving such a discount as a so-called point at the time of purchasing articles or services provided by the user themselves in order to secure a larger number of members.

However, in this method, since benefits are granted only to members who purchase the articles or services by visiting the on-line enterprise or recommenders who introduce new members, this method is not advantageous unless the number of members which one person can directly recommend is many or unless the loyalty of a joined member is high.

Further, since points granted to the members are comparatively smaller than an amount of money required at the time of purchasing the articles or services, the on-line enterprise virtually disregards the points because a considerable period of time is often consumed in reserving the points.

Additionally, if the amount or ratio of the reserved points increases, the profit of the enterprise decreases and the unit price of the article or service for profit becomes more conservative, thereby weakening price competitiveness with other competitors.

Further, since in case of an on-line commerce, a price difference for the same service or article can simply be verified for each site when a consumer wants to verify the difference, there is a problem in that price competitiveness is very intense and only inter-enterprise competition is triggered by the known method, such that excessive loss of profits should be endured.

### SUMMARY

Accordingly, embodiments of the present invention are contrived to solve the problem, Aspects of the present invention provide a method for electronic commerce capable of remarkably the number of members by enhancing an association relationship between members while reconsidering price competitiveness for articles or services provided from an on-line enterprise, a system, and a recording medium thereof.

Further, another aspect of the present invention is to provide a method for electronic commerce creating an increase in the number of members having loyalty by providing a higher incentive to a member inducing membership joining and the resultant activation of an on-line enterprise by generating points generated when a member having a GM member code subordinated to an SM member code purchases articles or services in the superior SM member code, a system, and a recording medium thereof.

In addition, yet another aspect of the present invention is to provide a method for electronic commerce in which even though a GM member operates an independent family line while the position of a GM member subordinated to an SM member having an independent position is changed into the SM member, a point which is continuously purchased by the known independent GM member is generated, such that a once constructed and nurtured family line has the permanent value of assets.

Other aspects, advantages, and new features of the present invention will be apparent by the following detailed description and preferred embodiments with reference to the accompanying drawings.

In order to achieve the above-mentioned objects, a method for electronic commerce using points depending on the grade of members on-line according to an embodiment of the present invention includes: a membership joining step of allowing a main server to join a non-member who is accessed through a wired/wireless communication network as a member; a GM member position granting step of granting the position of a GM member with respect to the member who is joined at the membership joining step, generating a GM member code, and subordinating the position of the GM member and the GM member code to the position and code of a recommender and the position and code of an SM member to which the recommender belongs; a member number determining step of checking whether the number of members having the GM member code subordinated to the recommender coincides with a predetermined number of members; and a member position changing step of, when the recommender is the GM member in the case where the numbers coincide with each other, changing the position of the recommender into the SM member and generating a new SM member code to separate it into an independent family line and maintaining the existing GM member code possessed by the recommender himself/herself as it is, wherein the SM member code and the GM member code subordinated to the SM member code form one family line to generate the points in the SM member code when the member having the GM member code subordinated to the SM member code purchases articles or services.

In addition, after the recommender forms the independent family line, the GM member position of a member joined by recommendation of the recommender is subordinated to the SM member position of the recommender and the GM member code of the member joined by the recommendation of the recommender is subordinated to the SM member code of the recommender.

Further, the points for the articles or services are reserved in the SM member code which is positioned in the highest layer of the family line to which the GM member code possessed by the person may be included when the person of which the position is changed into the position of the SM member by the member position changing step purchases the articles or services.

Moreover, the GM member position granting step may include whether or not the member purchases articles or services corresponding to a predetermined number of times or a predetermined amount of money; and when the member purchases the articles or services corresponding to the predetermined number of times or the predetermined amount of money, granting the GM member position and the GM member code.

Further, points generated in the SM member code may be cashed back or used to purchase the articles or services.

In addition, the points generated in the SM member code may be operated by setting a predetermined reserving period.

In this case, the points reserved in the SM member code are usable when the member having the SM member code purchases the articles or services for the reserving period.

Further, the points reserved in the SM member code may be vanished as many as a predetermined amount of money or a predetermined ratio when the member having the SM member code does not purchase articles or services corresponding to the predetermined amount of money or the predetermined ratio for the reserving period.

In addition, at the member number determining step, the number of GM members subordinated to the recommender may be the number of GM members joined by direct recommendation of the recommender.

In order to achieve the above-mentioned object, an electronic commerce system according to another embodiment of the present invention includes: a main server that initiates a non-member in a membership by receiving membership joining data including personal information of a non-member who is accessed through a wired/wireless communication network and an ID of a recommender who recommends the non-member, grants the position and code of the recommender and the position and code of a GM member subordinated to the position and code of an SM member to which the recommender belongs to the member, and judges whether a predetermined number of members coincides with the number of GM members subordinated to the recommender to change the position of the recommender and generate the corresponding code; a providing server that provides articles or services according to a request for purchasing the articles or services of a person who accesses the main server by using the wired/wireless communication network; a settlement server that takes charge of settlement by the purchasing; and an approval server that takes charge of member authentication and settlement approval by being connected with the main server and the settlement server.

In addition, the main server may include a WEB server providing information on access through a web browser and a transmission protocol, a WAP server operating a wireless Internet web browser of a WAP scheme, a point calculator calculates points generated when the member purchases the articles or services, a point reservoir that reserves the points calculated by the point calculator in the SM member code that is positioned in the highest layer of a family line to which a GM member code possessed by a member who purchase the articles or services is subordinated and reserves in an SM member code which is positioned in the highest layer of a family line to which the existing GM member code possessed by the SM member who purchases the articles or services when the member who purchases the articles or services is the SM member, a member position changer that checks whether or not the number of GM members subordinated to the recommender coincides with a predetermined number of members and when the numbers coincide with each other, changes the position of the recommender from the GM member to the SM member and generates the corresponding SM member code, and a database storing information on the articles or services and purchasing information of the member.

Further, the member position changer may set the changed SM member position and the generated SM member code as an independent family line.

In addition, the main server may further include an information opening unit that outputs the points reserved in the SM member code to the SM member and outputs points for each of articles or services to a purchaser. In order to achieve the above-mentioned object, according to yet another embodiment of the present invention, a computer-readable recording medium records a program for executing a membership joining step of receiving membership joining data including personal information of a non-member who is accessed through a wired/wireless communication network and an ID of a recommender who recommends the non-member, a GM member position granting step of granting the position of a GM member to the member which is joined at the membership joining step, generating a GM member code, and subordinating the position of the GM member and the GM member code to the position and code of the recommender and the position and code of an SM member to which the recommender belongs, a member number determining step of checking whether the number of members having the GM member code subordinated to the recommender coincides with a predetermined number of members, a member position changing step of, when the recommender is the GM member in the case where the numbers coincide with each other, changing the position of the recommender into the SM member and generating a new SM member code to separate it into an independent family line and maintaining the existing GM member code possessed by the recommender himself/herself as it is, and a step of allowing the SM member code and the GM member code subordinated to the SM member code to form one family line to generate the points in the SM member code when the member having the GM member code subordinated to the SM member code purchases articles or services.

In addition, the recording medium may include a program for executing a step of reserving the points for the articles or services in the SM member code which is positioned in the highest layer of the family line to which the GM member code possessed by the person may be included when the person of which the position is changed into the position of the SM member by the member position changing step purchases the articles or services.

Further, the recording medium may include a program for further executing a step of vanishing the points of the SM member at a predetermine amount of money or a predetermined ratio.

According to a method for electronic commerce using points depending on the grades of members on-line, a system, and a recording medium of the present invention, it is possible to remarkably increase the number of members by granting the position of an independent SM member to a GM member who attracts joining of a predetermined number of members (e.g., two members).

Further, it is possible to grant more points to the member who attracts membership joining by vesting points generated by a purchasing activity of the GM member subordinated to the SM member in a first generation of the corresponding SM member.

In addition, even though the known GM member operates an independent family line while the position of the GM member is changed into the SM member, the points are generated in an SM member code of a family line which a known GM member code is subordinated to if a member of which the position is changed to the SM member purchases services or articles, such that a once nurtured family line has the permanent value of assets.

Therefore, since the GM members actively perform a membership joining activity in order to be the SM member who can reserve many points, an on-line enterprise can achieve a remarkable increase in the number of members and the SM member can perform an inexpensive purchasing activity by utilizing the points as an incentive.

Further, it is possible to achieve increased sales of the on-line enterprise by enabling using the points generated in the SM member code at the time of repurchasing the articles or services.

### BRIEF DESCRIPTION OF THE DRAWINGS

The accompanying drawings, together with the specification illustrate exemplary embodiments of the present invention, and, together with the description, serve to explain the principles of the present invention. Therefore, it should not be understood that the present invention is limited to the details of the drawings.

FIG. 1 a family line diagram schematically illustrating the relationship between an SM member and a GM member according to an embodiment of the present invention and is a structural diagram illustrating reserving positions of points;

FIG. 2 is a flowchart of a method for electronic commerce using points depending on the grade of members on-line according to the present invention;

FIGS. 3 and 4 are hierarchical diagrams depending on a recommender according to the present invention;

FIGS. 5 and 6 are hierarchical diagrams illustrating a case where a GM member reaches a predetermined number (two persons) and the position of the GM member is changed into the position of an SM member to form an independent family line;

FIGS. 7 to 10 are hierarchical diagrams illustrating a case where a GM member reaches a predetermined number (two persons) and the position of the GM member is changed into the position of an SM member to form an independent family line;

FIG. 11 is a structural diagram when the position of a GM member is changed into the position of an SM member in a first family line to configure an independent family line (second family line);

FIG. 12 is a structural diagram when the position of a GM member is changed into the position of an SM member in a second family line to configure an independent family line (third family line);

FIG. 13 is a configuration diagram of an electronic commerce system using points depending on the grade of members on-line according to the present invention; and

FIG. 14 is a block diagram illustrating a schematic configuration of a main server.

### DETAILED DESCRIPTION OF THE PREFERRED EMBODIMENTS

Hereinafter, preferred embodiments of the present invention will be described in detail with reference to the accompanying drawings and tables. In addition, in the case where it is judged that the detailed description of known functions and configurations may obscure the gist of the present invention before describing the present invention, a description thereof will be omitted.

### <Description of Terms of SM Member and GM Member>

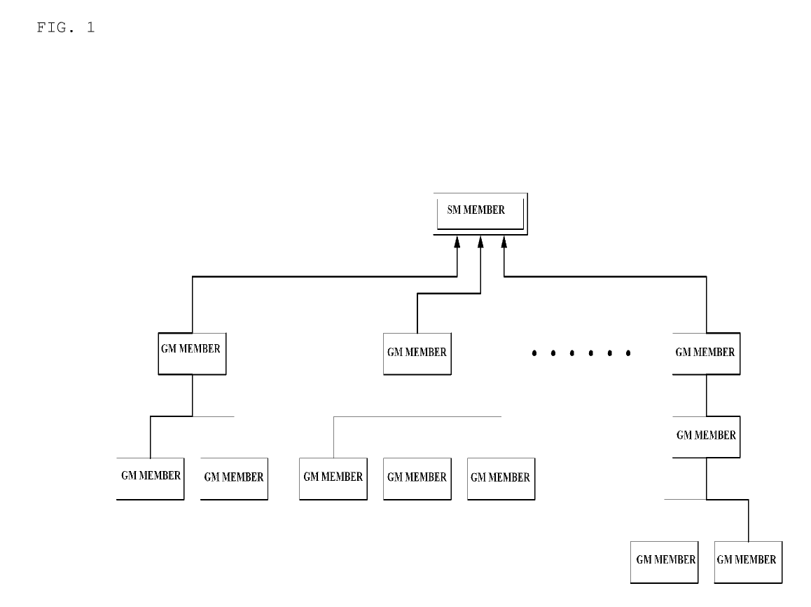

In this specification, a system master (SM) member as a user having a member qualification in an on-line enterprise represents a member who recommends and members of a predetermined number or more which are set by the on-line enterprise, and initiates them in a membership and nurtures them. The SM member has an SM member position and an SM member code corresponding thereto. The SM member acquires all points generated when a GM member subordinate to the SM member and all GM members subordinate to the GM member who purchase articles or services registered in the on-line enterprise as an incentive. FIG. 1 is a block diagram schematically showing hierarchical structures of an SM member and a GM member and the SM member is positioned on a highest layer in a continuous hierarchical structure. In FIG. 1, a start point of an arrow represents a member who purchases articles or services and an end point of the arrow represents a code of a member having a reserved point. That is, the points generated when the GM members subordinate to the SM member purchase the articles or services are reserved in the SM member code as shown in the figure. In this specification, the GM member, as a user having the member qualification in the on-line enterprise, represents a member hierarchically subordinate to an upper SM member as a person who does not yet acquire the position of the SM member. The GM member has a GM member position and a GM member code corresponding thereto. The GM member cannot reserve the points which a GM member subordinate to the GM member obtains in its own GM member code unlike the SM member. However, the GM member initiates members of a predetermined number (e.g., two persons) in the membership and when the GM member is recommended from the members, the GM member may be elevated to the SM member.

That is, when the GM member obtains a predetermined number of points by joining a membership or purchasing the articles or services by using his/her own ID after the membership joining at the time of purchasing the articles or service through the on-line enterprise, the GM member becomes the GM member. In addition, thereafter, when the corresponding GM member reaches the predetermined number (e.g., two persons) by directly recommending or initiating members in the membership or nurturing them, a new SM member code is generated while the GM member position is changed into the SM member position and a person who is changed into the SM member position forms the independent family line.

The independent SM member may directly recommend a junior member (GM member) without limitation of the number of members or recommend or nurture members of a predetermined number (e.g., one person or ten persons) for operation convenience of the on-line enterprise. That is, the GM member position and the GM member code of the GM member which the SM member forming the independent family line initiates in the membership afterwards are subordinated to the SM member position and the SM member code that form the independent family line, respectively.

The SM member is a system to which only a profit for only a first generation is applied, which is acquired as an incentive through generating the points by purchasing the articles or services of the GM member subordinate to the SM member and all GM members subordinate to the GM member in his/her member code (that is, SM member code).

Hereinafter, a method for electronic commerce using the points depending on the grade of members on-line, a system, and a recording medium thereof according to embodiments of the present invention will be described in detail on the basis of the defined concepts of the SM member and the GM member. <Method for Electronic Commerce>

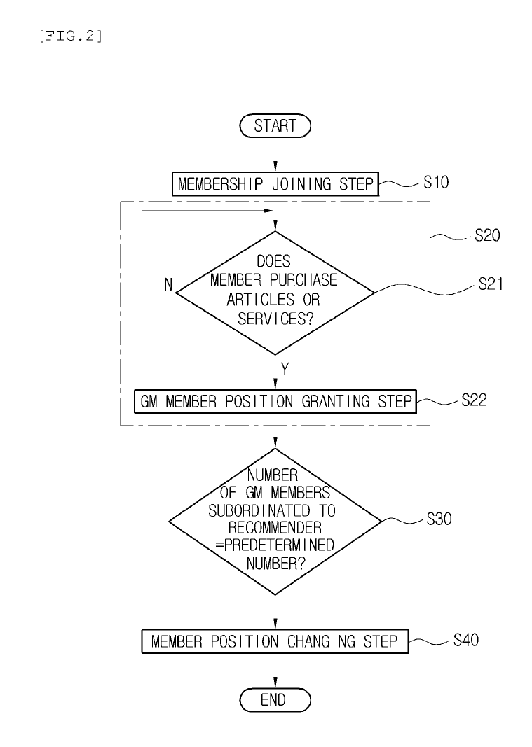

FIG. 2 is a flowchart depending on a method for electronic commerce using points depending on the grade of members on-line according to the present invention. The method for electronic commerce according to an embodiment of the present invention includes a membership joining step of allowing a main server to initiate a non-member who is accessed through a wired/wireless communication network in a membership (S10), a GM member position granting step of granting the position and code of a GM member to the person who is joined as the member (S20), a member number determining step of comparing and judging the number of GM members subordinate to a recommender with a predetermined number of members (S30), and a member position changing step of generating the position and code of an SM member capable of forming an independent family line when the recommender is the GM member if a condition is satisfied according to determining the number of members (S40).

First, the membership joining step (S10) will be described below. A person which is a non-member accesses the main server through the wired/wireless communication network to join a membership by recommendation of a person (recommender) who is the member of the on-line enterprise. The main server receives personal information (name, registration number, address, password, etc.) required for the non-member to join the membership and a recommender's ID.

Thereafter, when the non-member is registered as the member of the on-line enterprise, the main server grants the position of the GM member (GM member position) to a joiner and generates a GM member code corresponding thereto (S20). Granting the GM member position and generating the GM member code may be performed simultaneously with joining the membership. Further, granting the GM member position and generating the GM member code may be performed when the person joined as the member purchases articles or services of a predetermined number of times or a predetermined amount of money or more.

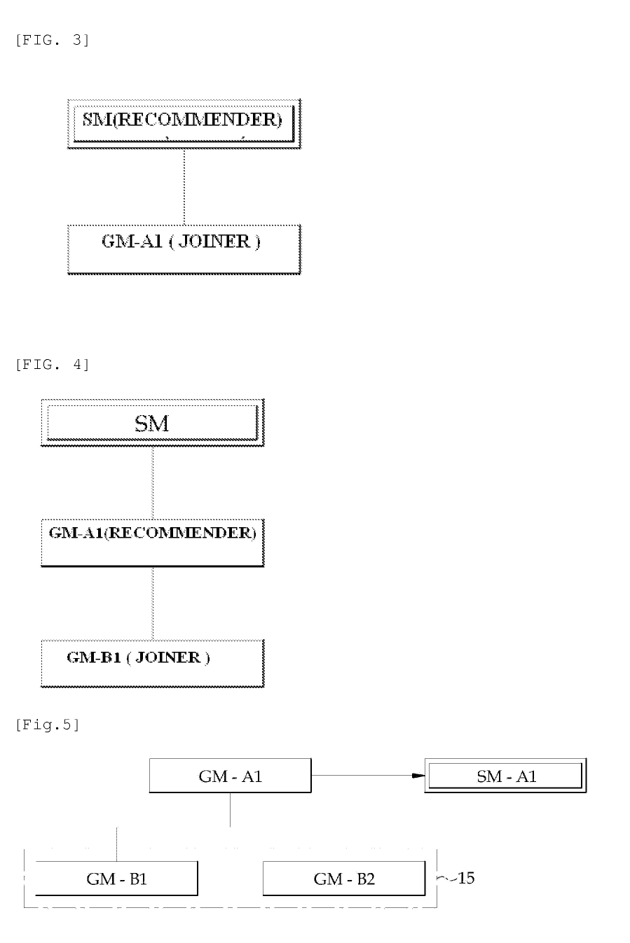

The GM member position and the GM member code are subordinate to the position and code of recommender and the position and code of the SM member which the recommender is subordinate to, respectively. That is, as shown in FIG. 3, when the recommender himself/herself is the SM member, the GM member position granted and the GM member code generated by the GM member position granting step (S20) are subordinate to the SM member position and the SM member code of the recommender, respectively. As another embodiment, as shown in FIG. 4, when the recommender is the GM member (GM-A1), the GM member position granted by the GM member position granting step (S20) is subordinate to the position of the recommender (GM member position and the position of the SM member positioned above the recommender (GM-A1). Further, the GM member code generated by the GM member position granting step (S20) is subordinate to the code of the recommender (GM member code) and the SM member code positioned above the recommender (GM-A1).

As a result of repetitively performing the membership joining step (S10) and the GM member position granting step (S20), when the number of the GM members subordinate to the recommender reaches the number of joined members (hereinafter, referred to as ‘predetermined number’) which the on-line enterprise targets, the recommender may form a new independent family line. A method for judging whether or not the number of the GM members subordinate to the recommender reaches the predetermined number is divided into two types. Hereinafter, in this specification, the predetermined number will be set to two persons for convenience of description.

In a first method, only members joined by “direct” recommendation of the recommender are counted. That is, as shown in FIG. 5, only GM members (GM-B1 and B2) joined by recommendation of the recommender (GM-A1) himself/herself are compared with a predetermined number (15:2 persons).

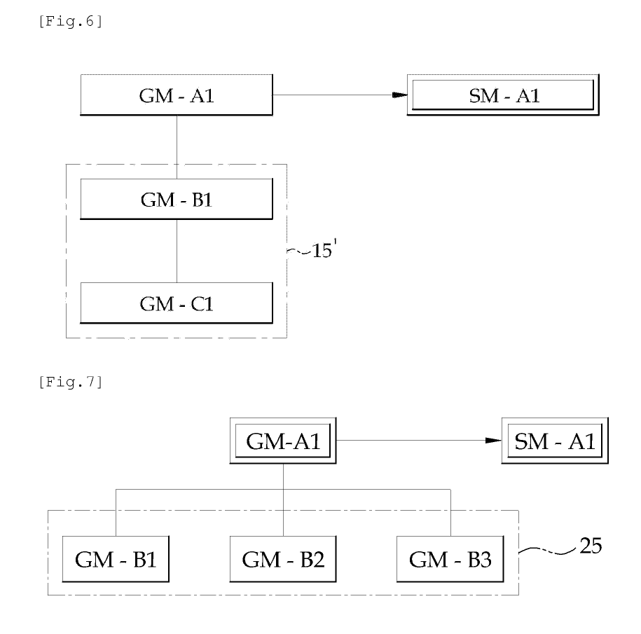

In a second method, members joined by “indirect” recommendation of the recommender are also included and counted. As shown in FIG. 6, there is a method for judging whether or not a value summing up the GM member (GM-B1) joined by direct recommendation of the recommender (GM-A1) himself/herself and a GM member (GM-C1) joined by recommendation (indirect recommendation) of the joined GM member (GM-B1) reaches a predetermined number (15′:2 persons).

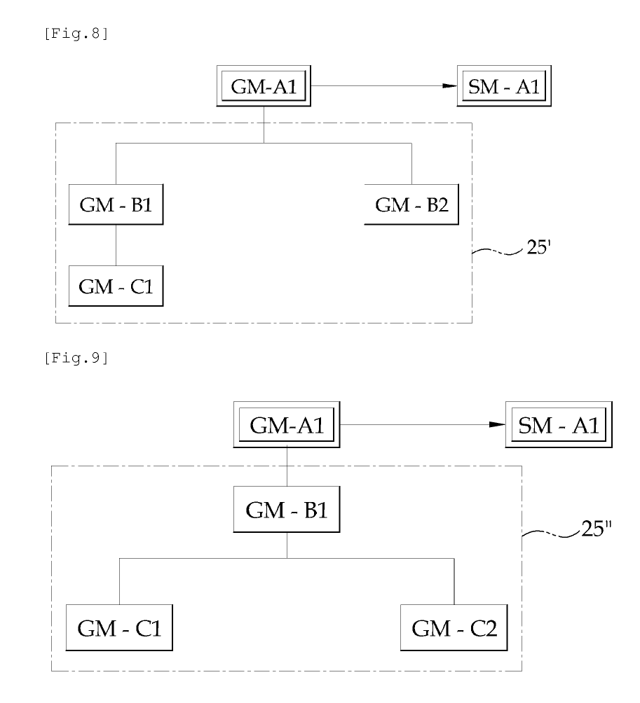

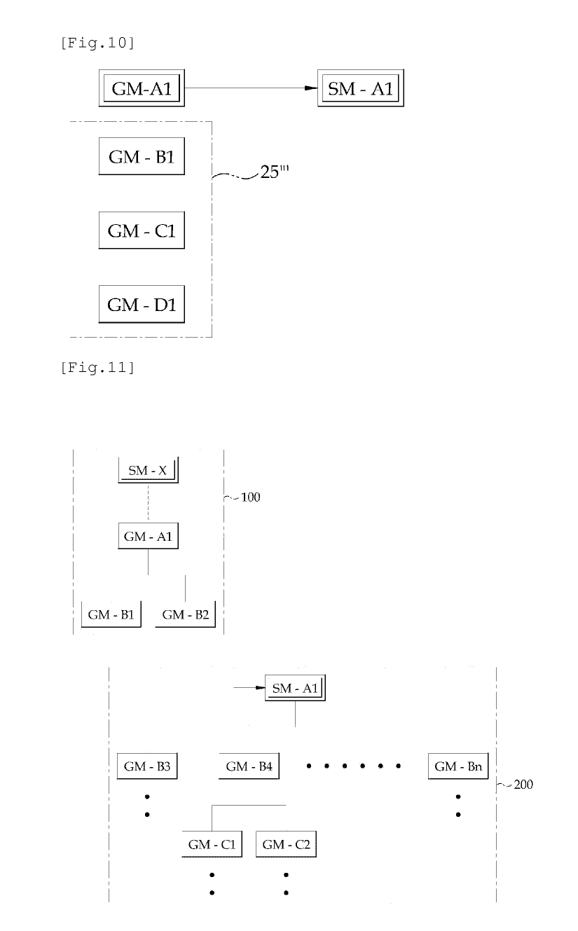

In the above-mentioned example, the predetermined number may, of course, be one or two persons. For example, when the member number determining step (S30) is executed by the direct or indirect recommendation of the recommender in the case where the predetermined number is three persons, various cases are available as shown in FIGS. 7 to 10. That is, when the predetermined number is set to three persons more than two persons, the independent family line may be formed while the position of the GM member corresponding to a case where the predetermined number is more is changed into the position of the SM member. Likewise, the on-line enterprise can secure more members while achieving various hierarchical structures. The predetermined number can be defined by the on-line enterprise.

More preferably, in the member number determining step (S30), as shown in FIG. 5, judging whether or not the counted number reaches the predetermined by counting only the number of the GM members (GM-B1 and B2) joined by the direct recommendation of the recommender (GM-A1) himself/herself is preferable in increasing the number of members.

Thereafter, as a result of the member number determining step (S30), in the case where the number of the GM members subordinate to the recommender reaches the predetermined number (e.g., two persons), when the recommender is the GM member, the member position changing step (S40) is performed, where the position of the GM member is changed into the SM member and the SM member code corresponding thereto is generated. That is, as shown in FIG. 11, a position which will form a new family line 200 (second family line) is granted while the position of the GM member (GM-A1) which is the recommender who initiates the members (GM-B1 and B2) of the predetermined number (e.g., two persons) in the first family line 100 is changed into an SM member (SM-A1). At the same time, an SM member code corresponding thereto is generated and the points are reserved in this SM member code.

After the new second family line 200 is formed, GM members (GM-B3, B4, . . . , Bn) which the SM member (SM-A1) subordinates by recommending a new non-member and GM members (GM-C1, C2, . . . ) which the GM members (GM-B3, B4, . . . , Bn) recommend and subordinate are subordinate to the SM member (SM-A1) which is positioned in a highest layer. That is, the positions of the new GM members (GM-B3, B4, Bn and GM-C1, C2, . . . ) and the GM member codes corresponding thereto are subordinate to the position and code of the SM member (SM-A1) of the second family line. Therefore, points generated when the new GM members (GM-B3, B4, . . . , Bn and GM-C1, C2, . . . ) purchase articles or services are reserved as the SM member (SM-A1) code which is positioned in the highest layer of the new GM member code.

On the contrary, after the new second family line 200 is formed, the points generated when the SM member (SM-A1) himself/herself purchases the articles or services or the points generated when the GM members (GM-B1 and B2) joined when is in the position of the existing GM member (GM-A1) purchase the articles or services are generated in an SM member code (SM-X) of the first family line, which the existing GM member code (GM-A1) is subordinate to.

That is, the GM member code possessed by the person who purchases the articles or service serves as a start point of reserving the point and the point is reserved as the SM member code which is positioned in the highest layer at the time of reversely tracking the GM member code which the corresponding purchaser possesses. Therefore, the SM member forming the new family line has an effort to initiate a new GM member in the membership in order to reserve more points generated as the SM member code of the SM member and join the new GM member because the GM member subordinate to the SM member wants to reserve the points by forming an independent family line through acquiring the position of the SM member.

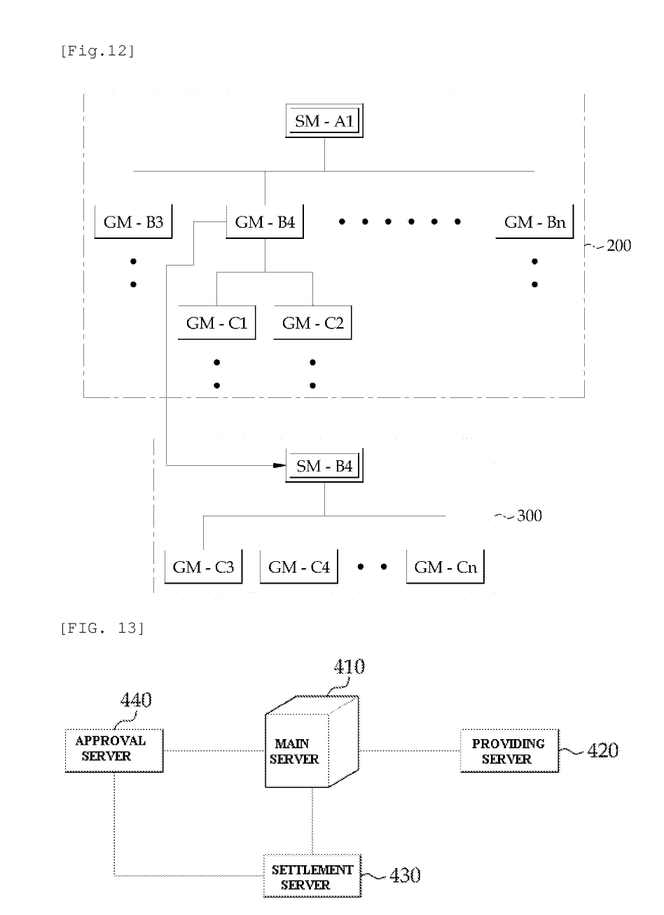

As shown in FIG. 12, the position of the GM member (GM-B4) to which the GM members (GM-C1 and C2) of the predetermined number (e.g., two persons) are subordinate in the second family line 200 is changed into the SM member (SM-B4) and the SM member code corresponding thereto is generated to form a new family line 300 (third family line).

In FIG. 12, when the SM member (SM-B4) which forms the third family line 300 purchases the articles or services or the GM members (GM-C1 and C2) joined when the SM member (SM-B4) is in the position of the existing GM member (GM-B4) purchases the articles or services, the corresponding points are reserved in the SM member code (SM-A1) of the second family line. In addition, when the GM members (GM-C3, C4, . . . , Cn) subordinate to the SM member (SM-B4) of the third family line 300 purchase the articles or services, the points are reserved in the SM member code (SM-B4) of the third family line.

This is fundamentally different from a multi-step sales scheme which is grown in a pyramid type as only one organic body and at which a predetermined profit generated when a new joiner purchases articles is bestowed to all superior joiners through several steps. The family line according to an embodiment of the present invention is a structure in which the points are reserved in only the first generation positioned in the highest layer of a small unit body by forming a family line of an independent small unit body.

The points reserved in the SM member code positioned in the highest layers of the first to third family lines are cashed back or usable at the time of purchasing the article or service. The points may be operated by setting a predetermined reserving period. As one embodiment, when members (SM-X member of the first family line, SM-A1 member of the second family line, or SM-B4 member of the third family line) having the SM member code in which the points are reserved purchase the article or services during the predetermined reserving period which the enterprise sets, the points can be used. Alternately, some of used and left points may be cashed back. On the contrary, when the members (SM-X member of the first family line, SM-A1 member of the second family line, or SM-B4 member of the third family line) having the SM member code in which the points are reserved do not purchase the article or services during the predetermined reserving period which the enterprise sets, the points corresponding to a predetermined amount of money or a predetermined ratio may be vanished. The on-line enterprise may determine the vanished points of the predetermined amount of money or the predetermined ratio by considering actual results of members, the number of members, etc. <Electronic Commerce System>

An electronic commerce system using points depending on the degree of members on-line largely includes a main server 410 that joins a member, grants the positions of an SM member and a GM member, and generates a code, a providing server 420 that provides articles or services according to a request for purchasing the articles or services of a person who accesses the main server by using a wired/wireless communication network, and a settlement server 430 that takes charge of a settlement operation by the purchasing, and an approval server 440 that takes charge of member authentication and settlement approval by being connected with the main server and the settlement server as shown in FIG. 13.

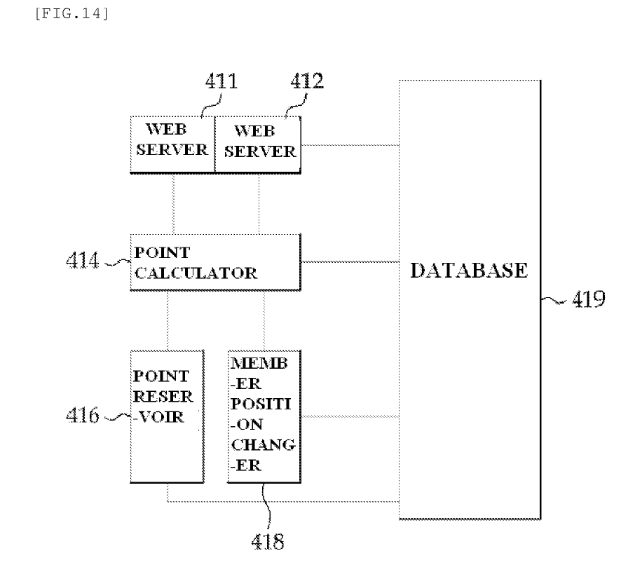

FIG. 14 is a block diagram schematically showing the structure of the main server 410. The main server 410 initiates a non-member in a membership by receiving membership joining data including personal information of the non-member and an ID of a recommender who recommends the non-member, grants the position and code of the recommender and the position and code of a GM member subordinate to the position and code of an SM member to which the recommender belongs to the person who is joined as the member, checks whether a predetermined number of members (a predetermined number) coincides with the number of GM members subordinated to the recommender and at this time, when the numbers coincide with each other and the recommender is the GM member, generates the SM member code while changing the position of the recommender from the GM member position to the SM member position.

The main server for taking charge of the function includes a WEB server 411, a WAP server 412, a point calculator 414, a point reservoir 416, a member position changer 418, and a database 419 storing related information.

The WEB server 411 providing information on access through a web browser and a transmission protocol and the WAP server 412 operating a wireless Internet web browser of a WAP scheme, such as a mobile communication terminal, a smart phone, or a PDA terminal provide a base for a user to access an on-line enterprise.

When the member (SM member or GM member) purchases the articles or services, the point calculator 414 calculates points generated by the purchasing.

When the number of GM members which the member (GM member or SM member) recommends and subordinates to himself/herself coincides with the predetermined number, the member position changer 418 changes the position of the member who recommends the membership joining and generates a code corresponding to the position.

That is, as described in FIGS. 11 and 12, when the recommenders (GM-A1 and GM-B4) which attract joining members of a predetermined number are the GM member, codes of the SM-A1 and SM-B4 corresponding to the position of the SM member are generated while the positions of the recommenders (GM-A1 and GM-B4) are changed into the SM members (SM-A1 and SM-B4). However, the codes of the existing GM members (GM-A1 and GM-B4) are maintained. The changed SM member position means that the SM member has a qualification capable of forming a new independent family line and the generated SM member code corresponds to an address where the points are reserved. Although the position of the recommender is changed and the new SM member code is bestowed, the GM member code generated when the recommender is the existing GM member is not vanished.

In addition, when the recommender is the SM member, the member position changer 418 does not need to newly change the position or generate the code because the SM member position and the SM member code are bestowed.

The point reservoir 416 reserves the points calculated by the point calculator 414 in the SM member code that is positioned in the highest layer of a family line to which a GM member code possessed by a member who purchase the articles or services is subordinate. This will be described with reference to FIGS. 11 and 12. For example, when the member who purchases the articles or services is a GM-B3 member of FIG. 12, the point reservoir 416 reserves the points in the SM member code of the SM-A1 member to which the corresponding GM member code is subordinate. As another example, a case where the member who purchases the articles or services is the SM-A1 member will be described below. When the member who purchases the articles or services is the SM-A1 member, even after the position of this person is changed into the SM member, this person possesses the existing GM member code. In this case, the existing possessed GM member code is prior to the new bestowed SM member code, such that the point reservoir 416 reserves the points corresponding to the articles or services purchased by the SM-A1 member in the SM member code of the SM-X member to which the existing GM member code (GM-A1) is subordinate.

The database 419 is a device in which various pieces of information required to drive the electronic commerce system are stored. The information stored in the database includes personal information including information such as an ID of the recommender, settlement processing information on article purchasing and settlement in the on-line enterprise, point reserving information, approval information for member authentication and settlement approval, hierarchical information between members, etc. Detailed information thereon belongs to the technical scope of those skilled in the art and a detailed description thereof will herein be omitted.

An information opening unit (not shown) outputs the points reserved in the SM member code to the SM member possessing the corresponding SM member code and outputs points for each of articles or services which a purchaser wants to purchase to all purchasers. Article information and points corresponding thereto or service information and points corresponding thereto which are stored in the information opening unit are provided to the purchaser through a computer monitor, an LCD display, etc. as an image display and characters (letters, figures, etc.).

### <Recording Medium>

The above-mentioned method for electronic commerce using cyber-pints depending on the grade of members on-line may be implemented by a computer-readable recording medium. In this recording medium is a program code or a command for executing a membership joining step of receiving membership joining data including personal information of a non-member who is accessed through a wired/wireless communication network and an ID of a recommender who recommends the non-member (S10), a GM member position granting step of granting the position of a GM member to the member which is joined at the membership joining step, generating a GM member code, and subordinating the position of the GM member and the GM member code to the position and code of the recommender and the position and code of an SM member to which the recommender belongs (S20), a member number determining step of checking whether the number of members having the GM member code subordinate to the recommender coincides with a predetermined number of members (S30), a member position changing step of, when the recommender is the GM member in the case where the numbers coincide with each other, changing the position of the recommender into the SM member and generating a new SM member code to separate it into an independent family line and maintaining the existing GM member code possessed by the recommender himself/herself as it is (S40), and a step of allowing the SM member code and the GM member code subordinated to the SM member code to form one family line to generate the points in the SM member code when the member having the GM member code subordinated to the SM member code purchases articles or services.

That is, the program code or commander included in the recording medium enables the above-mentioned method for electronic commerce using points depending on the grade of members on-line to be performed.

Further, the recording medium may include a program code or commander for executing a step of reserving the points for the articles or services in the SM member code which is positioned in the highest layer of the family line to which the GM member code possessed by the person may be included when the person of which the position is changed into the position of the SM member by the member position changing step (S40) purchases the articles or services.

Moreover, the recording medium may include a program code or command for performing a step of vanishing the points of the SM member at a predetermine amount of money or a predetermined ratio. The points may be performed for a predetermined period (e.g., the above-mentioned predetermined reserving period).

An example of the recording medium includes a floppy disk, a hard disk, a magnetic reel tape, optical disks (CD, DCD, blue-ray disk, etc.), semiconductor memories (RAM, ROM, EEPROM, USB memory, CF memory, SD memory, etc.), etc. The recording medium is not limited to the above-mentioned media. Those that are recorded and conserved as electronic data and readable by a computer are stored in the recording medium irrespective of the kind.

### Modified Example

As another embodiment, a method for electronic commerce using points depending on the grade of members on-line, a system, and a recording medium thereof are described in the present invention, but an embodiment of the present invention may generally be utilized even off-line. When a membership company which makes an affiliation contract or corresponding members (i.e., SM member and GM member) purchase articles or services off-line, they preferably authenticate a member and reserve points by recognizing a membership card connected with a main server. Even at this time, the articles or services can be purchased off-line with the points reserved in the SM member code. The used points are, of course, subtracted from the reserved points.

Although the present invention has been described with respect to the preferred embodiments, various modifications and changes can be made without departing from the spirit and scope of the present invention. Accordingly, the modifications or changes included in the spirit of the present invention will be included in the appended claims and their equivalents.

What is claimed is:

1. A method for electronic commerce using points depending on the grade of members on-line, comprising:
a membership joining step of allowing a main server to join a non-member who accesses through a wired/wireless communication network as a member;
a GM member position granting step of granting a position of a GM member with respect to the member who is joined during the membership joining step, generating a GM member code, and subordinating the position of the GM member and the GM member code to a position and code of a recommender and a position and code of SM member to which the recommender belongs;
a member number determining step of checking whether a number of members having the GM member code subordinated to the recommender coincides with a predetermined number of members; and
a member position changing step of, when the recommender is the GM member in the case where the numbers coincide with each other, changing the position of the recommender into the SM member and generating a new SM member code to separate the new SM member code into an independent family line and maintaining the existing GM member code possessed by the recommender himself/herself as it is,
wherein the SM member code and the GM member code subordinate to the SM member code form one family line to generate points in the SM member code when the member having the GM member code subordinate to the SM member code purchases articles or services.

2. The method for electronic commerce using points on-line according to claim 1, wherein after the recommender is separated into the independent family line, the GM member position of a member joined by recommendation of the recommender is subordinate to the SM member position of the recommender and the GM member code of the member joined by the recommendation of the recommender is subordinate to the SM member code of the recommender.

3. The method for electronic commerce using points on-line according to claim 1, wherein the points for the articles or services are reserved in the SM member code which is positioned in the highest layer of the family line to which the GM member code possessed by a person may be included when the person of which the position is changed into the position of the SM member by the member position changing step purchases the articles or services.

4. The method for electronic commerce using points on-line according to claim 1, wherein the GM member position granting step includes whether or not the member purchases articles or services corresponding to a predetermined number of times or a predetermined amount of money; and when the member purchases the articles or services corresponding to the predetermined number of times or the predetermined amount of money, granting the GM member position and the GM member code.

5. The method for electronic commerce using points on-line according to claim 1, wherein points generated in the SM member code are cashed back or used to purchase the articles or services.

6. The method for electronic commerce using points on-line according to claim 1, wherein the points generated in the SM member code are operated by setting a predetermined reserving period.

7. The method for electronic commerce using points on-line according to claim 6, wherein the points reserved in the SM member code are usable when the member having the SM member code purchases the articles or services for the reserving period.

8. The method for electronic commerce using points on-line according to claim 6, wherein the points reserved in the SM member code are vanished as many as a predetermined amount of money or a predetermined ratio when the member having the SM member code does not purchase articles or services corresponding to the predetermined amount of money or the predetermined ratio for the reserving period.

9. The method for electronic commerce using points on-line according to claim 1, wherein at the member number determining step, a number of GM members subordinate to the recommender is a number of GM members joined by direct recommendation of the recommender.

10. An electronic commerce system using points depending on the degree of members on-line, comprising:
a main server that initiates a non-member in a membership by receiving membership joining data including personal information of a non-member who accesses through a wired/wireless communication network and an ID of a recommender who recommends the non-member, grants a position and code of the recommender and a position and code of a GM member subordinate to a position and code of an SM member to which the recommender belongs to the member, and judges whether a predetermined number of members coincides with the number of GM members subordinated to the recommender to change the position of the recommender and generate the corresponding code;
a providing server that provides articles or services according to a request for purchasing the articles or services of a person who accesses the main server by using the wired/wireless communication network;
a settlement server that takes charge of settlement by the purchasing; and
an approval server that takes charge of member authentication and settlement approval by being connected with the main server and the settlement server.

11. The electronic commerce system using points depending on the degree of members on-line according to claim 1, wherein the main server includes a WEB server providing information on access through a web browser and a transmission protocol, a WAP server operating a wireless Internet web browser of a WAP scheme, a point calculator calculates points generated when the member purchases the articles or services, a point reservoir that reserves the points calculated by the point calculator in the SM member code that is positioned in the highest layer of a family line to which a GM member code possessed by a member who purchases the articles or services is subordinate and reserves in an SM member code which is positioned in a highest layer of a family line to which the existing GM member code possessed by the SM member who purchases the articles or services when the member who purchases the articles or services is the SM member, a member position changer that checks whether or not the number of GM members subordinated to the recommender coincides with a predetermined number of members and when the numbers coincide with each other, changes the position of the recommender from the GM member to the SM member and generates the corresponding SM member code, and a database storing information on the articles or services and purchasing information of the member.

12. The electronic commerce system using points depending on the degree of members on-line according to claim 11, wherein the member position changer sets the changed SM member position and the generated SM member code as an independent family line.

13. The electronic commerce system using points depending on the degree of members on-line according claim 10, wherein the main server further includes an information opening unit that outputs the points reserved in the SM member code to the SM member and outputs points for each of articles or services to a purchaser.

14. The electronic commerce system using points depending on the degree of members on-line according claim 11, wherein the main server further includes an information opening unit that outputs the points reserved in the SM member code to the SM member and outputs points for each of articles or services to a purchaser.

15. A computer-readable recording medium recording a program for executing a membership joining step of receiving membership joining data including personal information of a non-member who accesses through a wired/wireless communication network and an ID of a recommender who recommends the non-member, a GM member position granting step of granting a position of a GM member to the member which is joined at the membership joining step, generating a GM member code, and subordinating the position of the GM member and the GM member code to a position and code of the recommender and a position and code of an SM member to which the recommender belongs, a member number determining step of checking whether a number of members having the GM member code subordinated to the recommender coincides with a predetermined number of members, a member position changing step of, when the recommender is the GM member in the case where the numbers coincide with each other, changing the position of the recommender into the SM member and generating a new SM member code to separate the new SM member code into an independent family line and maintaining the existing GM member code possessed by the recommender himself/herself as it is, and a step of allowing the SM member code and the GM member code suboridnate to the SM member code to form one family line to generate points in the SM member code when the member having the GM member code subordinate to the SM member code purchases articles or services.

16. The computer-readable recording medium according to claim 15 recording a program for further executing a step of reserving the points for the articles or services in the SM member code which is positioned in the highest layer of the family line to which the GM member code possessed by the person may be included when a person of which the position is changed into the position of the SM member by the member position changing step purchases the articles or services.

17. The computer-readable recording medium according to claim 15 recording a program for further executing a step of vanishing the points of the SM member at a predetermine amount of money or a predetermined ratio.
